(19) United States
(12) Patent Application Publication
(10) Pub. No.: US 2025/0212930 A1
(43) Pub. Date: Jul. 3, 2025

(54) ENCAPSULATED FOOD PRODUCTS AND METHODS OF MAKING SAME

(71) Applicant: PHOOD STATION, Montréal (CA)

(72) Inventors: Diane LECLAIR BISSON, Montréal (CA); David DESJARDINS, Montréal (CA); Ali BAZMI, Montreal (CA)

(21) Appl. No.: 18/767,383

(22) Filed: Jul. 9, 2024

Related U.S. Application Data
(63) Continuation of application No. 15/754,832, filed on Feb. 23, 2018, now abandoned.

(51) Int. Cl. A23P 10/30; A23L 29/231; A23L 29/238; A23L 29/25; A23L 29/256; A23L 29/269; A23L 33/10; C12G 3/00

(52) U.S. Cl. CPC A23P 10/30; A23L 29/231; A23L 29/238; A23L 29/25; A23L 29/256; A23L 29/269; A23L 33/10; C12G 3/00; A23V 2002/00

(57) ABSTRACT

The present disclosure relates to a chewable non-gelatin soft capsule for encapsulating a bite size of semi-solid or a sip size of liquid material, the bite size of semi-solid or sip size of liquid material comprising an aqueous content of more than 20%, comprising a heat-sealable and thermoformable membrane of 0.9 to 2 mm in thickness, and a method of preparing non-gelatin soft capsules, the method comprising the general step of thermoforming a gelified film (membrane) into a capsule to will be filled with (mainly) food and/or beverages and to provide the organoleptic qualities and properties of food.

### CROSS-REFERENCE TO RELATED APPLICATIONS

This application is a continuation-in-part of U.S. application Ser. No. 15/754,832 filed Feb. 23, 2018, which is a U.S. National Phase of International Application No. PCT/CA2014/050857, filed on September, 2014 and claiming priority from U.S. provisional patent application 61/877,649 filed Sep. 13, 2013, and this application claims priority to and the benefit of the above-identified applications, each of which are incorporated by reference herewith in their entirety.

### TECHNICAL FIELD

The present invention relates to a non-gelatin soft capsule and a method of preparing same for encapsulating edible semi-solid or liquid materials.

### BACKGROUND ART

Today we are witnessing a growing interest in the concept of tasting. This phenomenon falls within an agribusiness and tourism economy relying more and more on knowledge of consumers—that is to say, the more discriminating knowledge of foods and beverages flavors, the valuation of traditional or local products and the discovery of new products and new flavors. Within this trend, the development of a culture of drinking is particularly evident. Wine tasting, the craze for cider and coffee, the recent emergence of wine bars and beer houses and the growing number of publications on the subject are all evidence of the explosive development of the phenomenon of tasting.

The two current practical commercial processes leading to food encapsulated products, spherification and encapsulation in soft gelatin capsule, both comprise limited applications for making a bite-size format edible soft capsule.

### Spherification

In recent years, due to the success of molecular gastronomy, consumers have experienced new tastes and food textures. Spherical gelified food products derive from the molecular gastronomy technique of spherification. The spheres have been given names such as caviar, beads or pearls. Spheres are made with hydrocolloids, predominantly agar agar or alginate, which produces two types of spheres. Agar agar produces a mass of gel, whereas alginate produces a gelified outer layer that encapsulates a liquid filling material. Both small and large-size spheres may be made with the process of spherification.

The spherification process using alginate as the predominant hydrocolloid consists of a controlled gelification of a liquid, which forms spheres when submerged in a bath. The resulting spheres have a thin membrane and are filled with the original liquid. There are two main kinds of spherification techniques. The basic spherification technique consists of submerging a liquid with sodium alginate in a bath of calcium. The reverse spherification technique consists of submerging a liquid with a mixture of calcium gluconate and calcium lactate in a bath of sodium alginate.

There is also a variation of this technique, frozen reverse spherification, which involves pre-freezing spheres containing calcium lactate gluconate and then submerging them in a sodium alginate bath. It is done using traditional freezing techniques or, in the presence of alcohol for example, using liquid nitrogen.

Both the processes and the ingredient, the alginate, comprise limited application for large-scale industrial production. The alginate gel, which can encapsulate liquid by way of spherification, presents significantly low water-barrier properties, thus a short shelf life. The high ratio of water normally found in the produced spheres results in the outer shell of the spheres being soft and fragile. Spheres need to be eaten rapidly after their fabrication in order to avoid inevitable syneresis or stored in a holding bath.

Examples of existing spherification techniques include patent application publication no. WO 2013/113027 which describes a process of enclosing or wrapping materials in natural transport systems allowing the encapsulation of an edible substance. The process described in WO 2013/113027 involves the formation of multi-layers for encapsulating an edible substance by using multiple bath submersions, in calcium solution and alginate for example. Liquid nitrogen is used to freeze the calcium carbonate mixture in moulds before bathing it in the alginate solution, producing a membrane covered frozen solid.

Current spherification techniques do not allow for commercialization of large size or bite size format. They afford predominantly for small format (up to 10 mm diameter), which makes the sphere a product exclusively used as an added ingredient in recipes or drinks.

Patent application publication no. U.S. 2009/0155427 A1, describes a method of producing an encapsulated alcohol bead using spherification technique with the particularity that the alcohol bead reacts when added to a hypotonic solution, the alcohol then flows through the pores in the coating and into the surrounding solution.

Although the spherification process, by using moulds, allows for diverse shapes, the shape definition is not refined as when produced by other processes such as the encapsulation process for example.

Spheres made with alginate also require conservation in an aqueous medium, making the spheres a product that needs to be handled with kitchen utensils rather than with the hands.

U.S. Pat. No. 4,507,327 discloses the preparation of encapsulated foods by way of spherification with the additional steps of exchanging the core liquid in the capsules with water by soaking the capsules of the core liquid in water to remove therefrom any unreacted calcium salt and then exchanging the core liquid in the capsules with an edible liquid by immersing the water-filled capsules in the edible liquid. This technique can be used to harden membranes, but still the resulting capsules need to be preserved by keeping them immersed in the edible liquid.

### Soft Shell Encapsulation

The second existing method for preparing capsules is the encapsulation process. It relates to the conventional manufacturing of soft capsules using the rotary die process. The encapsulation of a wide range of products in gelatin and non-gelatin shells is long-established (see for example U.S. Pat. Nos. 2,234,479 and 8,241,665).

Both the process and the ingredients in the traditional art of making encapsulation are generally used for the production of ingestible capsules, and comprise limited application for the production of edible non-gelatin softgel capsule of bite-size format.

Soft capsules have been developed or are adapted to ingestion of substance. They are not designed for eating. As such, they do not present organoleptic properties suitable for food products. Although, the soft shell is flexible, the material is difficult to chew.

One further limitation of the softgel capsules made with gelatin gels is that they cannot be filled with a high water concentration filling. Gelatin softgel films will dissolve rapidly in contact with filling containing more than 20% of water by weight (see EP 1809261 A1). Gelatin softgel is only stable in contact with filling ingredients such as oils, lipid emulsions, creams or other types of lipid filling for medicinal, pharmaceutical, nutritional or dietetic applications, as well as cosmetics, paints, and bath products applications (see U.S. Pat. No. 6,949,256, and EP 1809261 A1).

In addition, non-gelatin softgel capsules are limited to the encapsulation of highly basic or alkaline filling material (see EP 1809261 A1), or of fillings containing a high concentration of sugar (see U.S. Pat. No. 7,211,283).

Current softshell encapsulation technologies do not allow for the production of large-size soft capsule (over 10 mm) having a sufficiently thin and flexible membrane to provide a good mouth feel during consumption.

It is thus still extremely difficult as a practical matter to encapsulate beverages or food substances in capsules or spheres. It will be apparent to one skilled in the art that there is a need for a formulation and method to encapsulate food and drinks, in a larger size capsule with soft, edible and more resistant membrane presenting pleasant mouth feel, enhanced organoleptic properties, and affording for a longer shelf life.

### SUMMARY

In accordance with the present description there is now provided a non-gelatin soft capsule for encapsulating an edible semi-solid or a liquid material comprising a membrane comprising an hydrocolloid mixture; at least one phospholipid; at least one plasticizer; and at least one sugar.

It is more specifically provided an edible non-gelatin soft capsule for encapsulating a bite size of semi-solid or a sip size of liquid material, said bite size of semi-solid or sip size of liquid material comprising a content of at least 20% in water, comprising a heat-sealable and thermoformable membrane of 0.9 to 2 mm in thickness; said thermoformable membrane comprising an hydrocolloid mixture; at least one phospholipid; at least one plasticizer; and an agar coating.

In an embodiment, the hydrocolloid mixture comprises at least one of carrageenan, gum arabic, methyl cellulose hydroxypropyl, methyl cellulose, starch, and a mixture thereof.

In an embodiment, the starch is corn starch, water chestnut starch or maltodextrin.

In another embodiment, the at least one plasticizer is at least one of glycerin, polyethylene glycol, sorbitol, polyol, and a mixture thereof.

In an embodiment, the at least one sugar is at least one of glucose, fructose, galactose, sucrose, dextrose, and a mixture thereof

In an embodiment, the at least one phospholipid is lecithin

In an embodiment, the capsule further comprises at least one of gellan, xanthan gum, locust bean gum, inulin from Jerusalem artichoke, chicory, wax, resin, fatty acid, one monovalent or divalent cation, and a mixture thereof

In an embodiment, the wax is at least one of beeswax, carnauba wax, candelilla wax, and a mixture thereof.

In an embodiment, the resin is shellac

In an embodiment, the fatty acid is stearic acid.

In another embodiment, the one monovalent or divalent cation is at least one of sodium, potassium, calcium salts, and a mixture thereof

In an embodiment, the membrane has a pH of between 4 and 8.

In another embodiment, the membrane has a pH of 4.5.

In an embodiment, the capsule further comprises a pH buffer.

In an embodiment, the capsule further comprises fruit extracts, fruit concentrates, vegetable extracts, or vegetables concentrates.

In an embodiment, the capsule described herein further comprises cranberries, blueberries, broccoli, or onion extracts or concentrates.

In an embodiment, the capsule further comprises plant extracts, plant aromas, antioxidants, prebiotic, or probiotic.

In an embodiment, the capsule further comprises an anti-tacking or a softening agent.

In an embodiment, the membrane has a viscosity of from 1 to 10 Pa·s.

In an embodiment, the capsule further comprises a viscosity enhancer.

In an embodiment, the capsule further comprises a preservative.

In an embodiment, the capsule has volume between 1 ml to 10 ml.

In an embodiment, the capsule has volume of 7 ml.

In an embodiment, the capsule has a volume for containing at least 1 g to 10 g of material.

In an embodiment, the capsule has a volume for containing at least 7 g of material.

In an embodiment, the capsule has a diameter of 25 mm.

In an embodiment, the membrane has an elasticity of around 64%.

In another embodiment, the membrane has a firmness of between 29 g and 107 g.

In an embodiment, the capsule further comprises on the interior or exterior surface of the capsule at least one barrier layer.

In another embodiment, the barrier layer comprises at least one of a resin, a plasticizer, wax, and a bonding agent.

In another embodiment, the plasticizer is glycerine.

In another embodiment, the wax is beeswax, carnauba wax or candelilla wax.

In another embodiment, the bonding agent is an emulsifier.

In another embodiment, the emulsifier is an emulsifying hydrocolloid, a phospholipid, a milk protein, and a fat.

In another embodiment, the fat is cocoa butter.

In another embodiment, the capsule further comprises a bonding layer between the membrane and the barrier layer or between the at least one barrier layer.

In another embodiment, the bonding layer comprises at least one of an emulsifier, an emulsifying hydrocolloid, a phospholipid, a milk protein, and fat.

In another embodiment, the material is a fruit, a vegetable tree sap, tea, coffee, syrup, honey, a dairy product, an alcoholic beverage, a functional or health enhancing ingredient, maltodextrin, dextrose, or a preparation of medicinal substances or pharmaceutical formulation.

In another embodiment, the alcoholic beverage is an ice cider, an ice wine, a spirit, a beer, a wine, or a mixed drink.

In another embodiment, the functional or health enhancing ingredient is a plant extract, an antioxidant, a prebiotic or a probiotic.

In another embodiment, the material comprises a pH buffer or a thickening agent.

In another embodiment, the material comprises a preservative.

In accordance with the present description there is now provided a process for manufacturing a non-gelatin soft capsule encapsulating an edible semi-solid or a liquid material comprising the steps of mixing an hydrocolloid, at least one phospholipid, at least one plasticizer and at least one sugar; heating said mixture at a temperature of about 60° C. to about 100° C. forming a membrane; reducing or removing all air bubbles in the membrane; shaping the membrane into the capsule; and depositing or injecting the material in said capsule.

In an embodiment, the mixture is heated at a temperature between 75° C. and 95° C.

In another embodiment, the air bubbles are reduced or removed by applying a vacuum.

In a further embodiment, the vacuum is applied by using a vacuum pump, a deaerator, or a vibrating table.

In an additional embodiment, the vacuum is applied at a pressure of on or about 75 kPa.

In an embodiment, the process further comprises the step of applying at least one barrier layer on the interior or exterior surface of the membrane.

In an embodiment, a bonding agent is used to insure adhesion of the at least one barrier layer.

In an embodiment, the at least one barrier layer and bonding agent are applied before, during or after the thermoforming of capsules.

In an embodiment, the at least one barrier layer and bonding agent are applied by a coating process.

In an embodiment, the coating process is spray chilling, spray cooling, powder coating, spray drying, brushing, dipping, or complex coacervation.

In an embodiment, the shaping of the membrane into the capsule comprises forming two capsule portions, and filling, sealing and cutting the capsules in one simultaneous step or multiple steps.

In an embodiment, the membrane is formed by extruding through two extrusion dies or casting said mixture to form the membrane.

In an embodiment, the membrane has a thickness ranging from 0.9 mm to 1.8 mm.

In an embodiment, the membrane is placed in a die having a female mould and a male plug to thermoform by compression the two capsule portions of the capsule.

In an embodiment, the mould is heated to temperature of around 60° C.

In an embodiment, the mould is further cooled after being heated.

In an embodiment, the mould is cooled by circulation of cold water in the mould.

In an embodiment, the material is deposited in of the two capsule portions, and the two capsule portions are sealed.

In an embodiment, the two capsule portions are sealed and the material is injected afterwards or simultaneously as the two capsule portions are sealed.

In an embodiment, the mixture or membrane is compressed.

In an embodiment, the mixture has a viscosity higher than 4.5 Pa·s.

In an embodiment, the membrane is further dehydrated.

In another embodiment, the process described herein further comprises a final step of drying the capsule to a desired moisture content.

In another embodiment, the process described herein further comprises the step of adding a texture by embossing, spraying or printing image, figure, art, graphic, character, text or words on the capsule.

In a further embodiment, the process described herein comprises feeding the membrane into an encapsulation area of an encapsulation machine creating a continuous sheet, and the material is injected between two sheets of membrane, and wherein further the sheets are sealed together.

### BRIEF DESCRIPTION OF THE DRAWINGS

FIG. 1 illustrates photographic representations of the capsule according to one embodiment described herein.

FIG. 2 illustrates a graph of the TAXT2 texture analyzer showing the resistance of the films in accordance to an embodiment against stretching.

### DETAILED DESCRIPTION

It is provided a non-gelatin soft capsule encapsulating edible semi-solid or liquid materials and a process for making same.

Current methods of making capsules in a bite size format rely on spherification and on the use of alginate as the main gelling agent, which produce a fragile sphere with very poor water barrier properties. Initial experimentation conducted with the process of spherification and reverse spherification further confirmed these limitations. These limitations have led to the development of a non-alginate based mixture and of processes more suitable for a longer shelf life of capsules, as well as for large-scale manufacturing processes such as thermoforming processes.

Thus, it is provided herein a non-gelatin gel mixture that can be used with thermoforming processes for making capsules. The final product is a capsule that creates a bursting effect in the mouth when chewing on it. It can be chewed and dissolves rapidly in the mouth. It is an edible object created primarily for the food and beverage industry. The capsules produce can be advantageously of a larger size than what is commercially available. The capsule varies in shape and in volume with an average volume of 7 ml for example. It is also encompassed a bite size or sip size format, which is of larger size than what is commercially produced by way of spherification or encapsulation. The filling materials take part in the taste experience of the capsule and include ingredients such as fruit and vegetable juices and/or powders, and/or purees; alcoholic beverages; spices; aromas, and/or other flavours and the like or a mixture thereof or equivalents thereof. Due to the high barrier properties of the membrane, and of added water barrier layer or layers, the capsule has a longer shelf life than capsules produced by existing methods. The capsule is formed, filled, sealed and cut with said suitable ingredients in a continuous or non-continuous process. The continuous process relates to the processes such as the encapsulation process. Non-continuous processes for making capsules relates to at least a two-step process including for example compression thermoforming of two capsule portions, and filling, sealing and cutting the capsules. Both continuous and non-continuous processes permit the production of diverse well-defined shapes. Thermoforming is commonly used in the food industry; however, it has not been used for making large size capsules. The capsule is packaged in a non-aqueous medium making it easy to handle from the hand to the mouth.

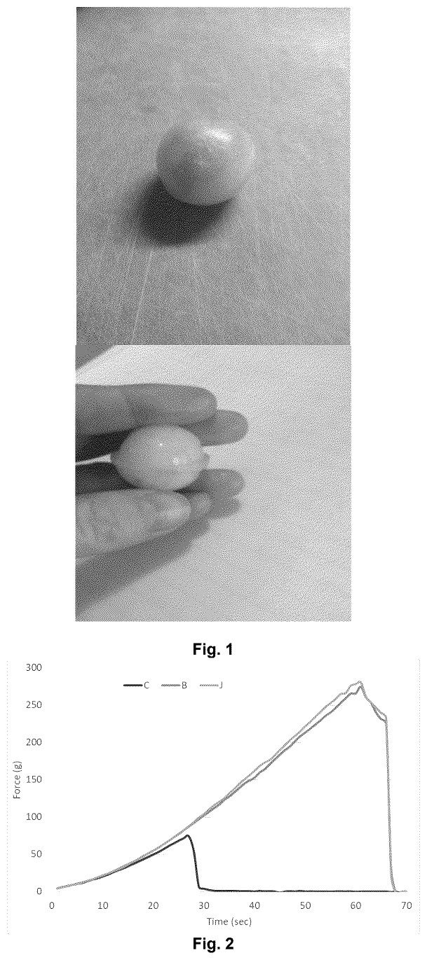

In an embodiment, it is provided a method of making an edible membrane (also referred as a matrix or shell interchangeably herein) to encapsulate edible semi-solid or liquid materials by way of thermoforming processes. An example of such capsule is seen in FIG. 1.

As encompassed herein, the membrane is made from a hydrocolloid-based mixture that excludes the use of alginate, providing the desired gelling characteristics and textural properties. Preliminary tests have been conducted to evaluate spherification as a potential process for industrial production of soft edible capsules. The initial experimentation as mentioned hereinabove conducted with alginate and spherification has confirmed the limitations of the spherification process and led to the choice of a non-alginate based mixture. The freezing of the filling material considerably limited the range of edible substances to be encapsulated. In addition, tests made with alginate following the reverse spherification process presented syneresis within two hours (see Example I). Optimized alginate mixture including ingredients such as gum arabic and agar, have shown syneresis 24 hours after the spheres were produced (see Example I). As a result, the matrix of the sphere tears rapidly.

As described herein, a gel mixture formulation has been developed to make a soft but more resistant edible membrane and capsule that does not need to be stored in an aqueous solution and provides a longer shelf-life.

In an embodiment, the capsule comprises a bursting effect in the mouth from the filling material liberated when chewing on the capsule. The dimension of the capsule, and the thickness and texture of the shell material contribute to the bursting effect in the mouth.

In an embodiment, it is provided a method of making a large size edible capsule of approximately 7 ml in volume for sip size format and approximately 7 g for bite size format. The capsules can be produced in a variety of sizes and shapes with volumes ranging from 1 ml to 10 ml or from 1 g to 10 g. For example, in a preferred embodiment, a spherical capsule of 25 mm in diameter of an average of 7 ml of filling material is produced. The capsule can be equivalent in volume to a food bite or a sip of liquid.

In an embodiment, the method described herein provides a thin membrane, with thickness varying from 0.9 mm to 2 mm, suitable for food consumption and providing a good mouth feel. The method described herein also provides a soft but resistant membrane and capsule.

The thermoformed gelified membrane described herein produces a dense matrix, which may act as a liquid and vapor barrier. Hence, the thermoformed gelified membrane reduces the liquid and vapor transfer from the filling to the membrane, providing longer shelf life than existing products produced by known methods producing large size capsules, with a shelf life for the capsule described herein that varies between one week and three months according to the filling material encapsulated.

The shelf life of the gelified capsule may be extended by forming multiple food layers inside or outside the capsule, before, during or following the thermoforming of the capsule.

As described herein, more resistant hydrocolloid combinations have been developed to create a longer shelf-life product.

In an embodiment, the gel membrane is made from a mixture of: i) hydrocolloids including carrageenan, gum arabic, hydroxypropyl methylcellulose, methyl cellulose, and/or starch such as corn starch, water chestnut starch, maltodextrin or equivalents thereof; ii) at least one plasticizer selected from a group consisting of glycerin, polyethylene glycol, sorbitol, polyol, and others of the sort or a mixture thereof; iii) at least one sugar such as glucose, fructose, galactose, sucrose, dextrose, and others of the sort or a mixture thereof; and iv) at least one phospholipid such as lecithin.

As provided herewith, an edible non-gelatin soft capsule for encapsulating a bite size of semi-solid or a sip size of liquid material is provided, said bite size of semi-solid or sip size of liquid material comprising a content of at least 20% in water, comprising a heat-sealable and thermoformable membrane of 0.9 to 2 mm in thickness; the thermoformable membrane comprising an hydrocolloid mixture; at least one phospholipid; at least one plasticizer; and an agar coating.

Coating with agar was successful as 100% impermeability was achieved for 6 months, contrary to using other coating agents like wax. The utilization of carrageenan and various other polymers to encapsulate liquid fill materials, even with a minor presence of water, represents a highly specialized and intricate process that is not easily replicable by someone skilled in the art. Achieving the desired encapsulation properties while maintaining the integrity and stability of both the polymer matrix and the liquid core necessitates a deep understanding of polymer chemistry and rheology. use of agar as a coating for vegetarian capsules to achieve chewable properties and mimic the characteristics of gelatin capsules is a highly specialized and complex process that cannot be easily replicated by someone skilled in the art. It involves a deep understanding of the unique properties of agar, including its gelling behavior, texture, and stability, as well as its interactions with the capsule material. The development of such a formulation often entails extensive research and experimentation to optimize the sensory attributes and ensure product consistency. Without the coating of agar, loss of water content increases over time and makes it an unviable product after more than 7 days of shelf-life. When the coating is present, the capsule is stable and non significant loss of water is observed even after 35 days of shelf life.

Accordingly, the provided capsule or sphere comprises a membrane that can be likened to a hollow sphere. To withstand mechanical stress without breaking, the larger the diameter of the sphere, the thicker the wall will need to be or the stronger the membrane will be. It is understood that for a large diameter of sphere (“bite-sized”), such sphere is around 13.78 mm in diameter (for 5 ml). The membrane must have a much higher mechanical strength than in the case of a small diameter sphere such as that found in commercially available capsules (5 to 10 mm for spherical softgel capsules), otherwise it may rupture during manufacture, transport and handling.

In some embodiments, the combination of hydrocolloids may include: gellan, xanthan gum, locust bean gum, inulin from Jerusalem artichoke, chicory or other oligosaccharides, and others of the sort or a mixture thereof.

In some embodiments, the mixture also includes wax such as beeswax, carnauba wax, candelilla wax, and others of the sort or a mixture thereof.

In some embodiments, the mixture also includes a resin such as shellac.

In some embodiments, the mixture also includes a fatty acid such as stearic acid.

In some embodiments, the mixture also includes one monovalent or divalent cation, such as sodium, potassium, and calcium salts, and others of the sort or a mixture thereof.

In some embodiments, the cations may be applied to the membrane by way of spray solution.

In one embodiment, the pH of the membrane is between 4 and 8. The carrageenan is more efficient at a pH of 4.5. Accordingly, the mixture can include a pH buffer.

The gel membrane may include inexhaustible range of flavors and aromas to create flavor pairing with the filling material.

In some embodiments, the mixture may further include flavoring ingredients. The capsules shell can be neutral in taste or flavored to complete, match or contrast the tasting of the semi-solid or liquid core. The mixture can offer inexhaustible range of flavor combinations. By way of example, the shell could include in its components: fruit extracts and/or vegetable extracts and concentrates, from for example cranberries, blueberries, broccoli, onion, plant and botanical extracts, aromas, and others of the sort or a mixture thereof.

In some embodiments, the mixture can include functional and/or health enhancing ingredients such as fruit extracts and/or vegetable extracts and concentrates, antioxidants, plant and botanical extracts, prebiotic and probiotic, and the like or a mixture thereof or equivalents thereof.

In some embodiments, the mixture further comprises an anti-tacking and/or a softening agent.

As described herein, the viscosity of the mixture may vary from 1 to 10 Pa·s according to the thermoforming process utilized to produce capsules. The mixture can comprise a viscosity enhancer if needed.

In some embodiments, the mixture further comprises a preservative.

In another embodiment, the mixture can be transparent or opaque, comprising visible natural coloring additives. The gelified membrane remains stable with the addition into the gel mixture of natural coloring additives in a liquid form.

The membrane described herein presents functional properties contributing to making the membrane a significantly greater water barrier than membranes produced by spherification or encapsulation, and a resistant shell. Functional properties of gelified membrane include: i) stability of membrane in contact with the liquid content; ii) low percentage of solid and liquid material transfer between the filling and the membrane; iii) high elasticity; and iv) high firmness.

Accordingly, transfer of solids contained in the membrane to the liquid filling material is around 9% and stable after 24 hours. Membrane samples of 43 mm in diameter have been individually immersed in a beaker filled with apple juice for a period of three months at 4° C. The weight of solid content transferred from the membrane to the juice has been measured at different moments from 24 hours, up to three months with a Sartorius MA45.

The transfer of liquid from the filling material into the membrane (absorption amount) is around 14%, reduces of around 2% between one to five days, and remains stable after. Membrane samples of 43 mm in diameter have been individually immersed in a beaker filled with apple juice for a period of three months at 4° C. The weight of liquid content transferred from the liquid filling to the membrane has been measured by weighing the membrane during the test time.

The membrane described herein is stable in contact with a liquid filling. The membrane mixture does not dissolve in contact with a liquid filling material. Observation of the integrity of the texture of the membranes shows it remains stable over a period of three months.

In an embodiment, the elasticity of the membrane is around 64%. Elasticity tests were performed with Stable Micro System TA-xT2i Texture Analyzer. A specific method was developed for this test. The elasticity was measured in static mode and the membrane was subjected to a growing load. A strip of membrane was placed between two plates. Every plate has a hole of 15 mm in diameter in the center. By this method, a punch, with a spherical tip of 8 mm in diameter exercises a force on the surface of the membrane up to the point of rupture. The more the membrane is resistant, the more the punch sinks into the membrane and deforms it. For a diameter of 15 mm, the increase of the length of the film before rupture was 9.7 mm.

In an embodiment, the firmness of the membrane is between 29 g and 107 g. Firmness tests were also performed with Stable Micro System TA-xT2i Texture Analyzer, following the same procedure as the one used for the elasticity test. Strips of membranes were deforming under the applied force of 29 g to 107 g before the membrane deformed.

In comparison with the alginate membrane produced following the known method of spherification, the membrane as described herein, which has similar humidity content, shows greater mechanical strength, and presents high water barrier properties. The alginate membrane is too fragile to be submitted to measures of firmness, rigidity and elasticity. Mechanical parameters are included in table 1 for comparison.

TABLE 1
Comparative analysis between an alginate
membrane and the said membrane

| | Alginate membrane | | Said membrane | |
|---|---|---|---|---|
| Humidity | 68.97% | | 61% | |
| Density | 0.83 | g/ml | 1.07 | g/ml |

| | | | |
|---|---|---|---|
| Thickness | 0.41 | mm | 0.9 mm-1.5 mm |

| | | | |
|---|---|---|---|
| Firmness | na | 10 | g |
| Rigidity | na | 71 | g/s |

| | | |
|---|---|---|
| Elasticity | na | 45% |

In some embodiments, the membrane may receive on the interior or exterior surface a barrier layer or layers that may further reduce or prevent the migration of water present in the filling through the membrane as well as water vapour migration. The layer or layers may be applied before or during the thermoforming process.

Ingredients suitable for use as encompassed herein for the barrier layer or layers include: resins, plasticizers such as glycerine, wax such as beeswax, carnauba wax, candelilla wax, and bonding agents such as emulsifiers, emulsifying hydrocolloids, phospholipids, milk proteins, and fats such as cocoa butter.

In some embodiments, a bonding layer may be applied between the membrane and the barrier layer and/or between the barrier layers to insure better adhesion of the barrier layer or layers on the capsule.

Suitable ingredients for making the bonding layer or layers include: emulsifiers, emulsifying hydrocolloids, phospholipids, milk proteins, and fats.

As encompassed herein, the filling material include liquid or semi-liquid ingredients, from fruits and vegetables (juice, powder and/or puree), tree sap, tea, coffee, syrups, honey, dairy products and alternatives, alcoholic beverages including ice cider, ice wine, spirits, mixed drinks, or any beverages containing around 10% of solids; flavoring ingredients including aromas; functional and/or health enhancing ingredients such as plant and botanical extracts, antioxidants, prebiotics and probiotics; maltodextrin, dextrose, and/or other stabilisers; preparation of medicinal substances or pharmaceutical formulation such as syrup; and the like or a mixture thereof or equivalents thereof.

In addition to the food and beverage industry, large-format capsules are particularly of interest to the pharmaceutical industry given that it allows greater dosage for formulations making capsules edible rather than ingestible and/or providing improved organoleptic properties compared to what is currently offered on the market.

In an embodiment, the filling material includes a pH buffer and/or a thickening agent.

In some embodiments, the filling material includes preservatives.

Due to the high barrier properties of the membrane, and of added water barrier layer or layers, the capsule has a longer shelf life than capsules produced by existing methods. Shelf life is in between 1 week to 3 months refrigerated.

It is thus provided an edible gelified membrane using the said mixture. The membrane is directed at encapsulating edible substances of a bite size format, and/or drinkable substances of a sip size format, using thermoforming processes adapted for the said membrane.

The present description relates to thermoforming processes, rather than the spherification process. Diverse methods of thermoforming may be utilized to make large size capsules. The methods for making the capsule may include a continuous or a non-continuous process. In all methods, a membrane is first made, and then shaped into half-portion capsules that are sealed and cut.

In general, the method described herein comprises the steps of: i) mixing the suitable ingredients to make the gel mixture ii) heating the mixture; iii) reducing or removing all air bubbles in the mixture iv) transferring the mixture to a mould or a machine configured for producing capsules.

The gel mixture is heated at temperature between 60° C. to about 100° C., preferable between 75° C. and 95° C.

In an embodiment, the process described herein comprises the step of applying a vacuum method to the mixture by way of diverse devices such as vacuum pump or deaerator, a vibrating table or other devices of the sort, at a pressure of on or about 75 kPa to reduce, remove or eliminate air, air bubbles and gas therefrom after the heating step.

The process described herein further comprises the step of maintaining the mixture at temperature between 60° C. to about 100° C., preferable between 75° C. and 95° C. until all air bubbles are removed from the mixture.

In an embodiment, one or more barrier layers may be applied on the interior or exterior surface of the membrane, to reduce the migration of filling material through the membrane. The barrier layer or layers may be applied on the membrane before or during the thermoforming process by way of coating processes such as spray chilling, spray cooling, powder coating, spray drying, brushing, dipping and complex coacervation.

In an embodiment, a bonding agent is utilized to insure better adhesion of the barrier layer or layers. The bonding layer may be applied between the membrane and the barrier layer and/or between the barrier layers. The bonding layer or layers may be applied before or during the thermoforming process by way of coating processes such as spray chilling, spray cooling, powder coating, spray drying, brushing, dipping and complex coacervation.

In one embodiment, methods of making capsules relate to a non-continuous process including the steps of i) thermoforming two capsule portions; and ii) filling, sealing and cutting the capsules in one simultaneous step or multiple steps. The thermoforming permits the production of diverse well-defined shapes. These methods replace current methods of forming and encapsulating food and beverage capsules.

The method of this embodiment further comprises the steps of: i) extruding through two extrusion dies or casting said suitable mixture to form a membrane of a thickness ranging from 0.9 to 1.8 mm; and ii) placing formed membrane in a die having a female mould and a male plug to thermoform by compression the two half portions of the capsule corresponding to the shape of desired capsule.

The mould can be heated to temperature of around 60° C. Afterwards, the mould can be cooled by cooling methods such as circulation of cold water in the mould.

In an embodiment, the filling is deposited in the first and the second half of preformed half capsules, and the two half capsules are sealed. The final shape of the filling material can be pre-shaped in a mould or frozen in a mould, deposited in one half, after which the two half capsules are sealed.

The filling and sealing of the two half portions and the cutting of the capsule can also be done by way of a second step or multiple steps, following a horizontal or vertical system. For example, the two half portions of the capsule can be sealed, and injected with the filling material. The filling material can alternatively be injected simultaneously as the two half portions of the capsule are sealed.

The process described herein improves the strength of the capsule membrane by way of compression of the mixture or of the preformed gelified membrane. The mixture or pre-formed membrane is heated at a temperature, moisture content and time sufficient to produce compact formed membrane.

Alternatively, in another embodiment, the membrane may be formed and filled with the suitable ingredients, in a single continuous operation by a form, fill, seal, and cut process. This one-step method of making capsules relates to the traditional art of making encapsulated bath beads, paint balls, and pharmaceuticals.

The process of this embodiment for producing capsules, further comprises the steps of transferring the suitable mixture to a machine configured for extruding the membrane.

In some embodiments of this process, the gel mixture has a viscosity higher than 4.5 Pa·s.

The mixture can be extruded through two extrusion dies directly into two tension rollers to form a membrane of a thickness ranging from 0.9 to 1.8 mm. Two extruded films are then passed over rotating dies which simultaneously form, fill, heat-seal and cut the capsules.

In some embodiments of the described process, the extruded membrane is dehydrated to obtain suitable texture and elasticity to pass through the tension rollers. In this embodiment, the softgel machine is modified to introduce a dehydrating device and/or casting mould to help solidify the membrane before it passes through the tension rollers.

In some embodiments, a new capsule die-mould, designed for better sealing performance of said membrane, is utilized. The membrane has been tested with both non-continuous and continuous processes using existing capsule die-moulds to examine the sealing performance of the moulds.

The capsule described herein can be dried to a desired moisture content and may present a smooth surface or a textured surface produced by the mould or by ways of embossing, spraying or printing image, figure, art, graphic, character, text and/or words.

It is encompassed herein a method for encapsulating the formulation utilizes softgel encapsulation equipment. This process begins with the preparation of the shell material, composed of the formulation. The shell material is heated and maintained at a specific temperature to achieve the desired viscosity for the encapsulation process. Simultaneously, the fill formulation is prepared and stored in a temperature-controlled tank to ensure optimal consistency.

The encapsulation machine, equipped with rotating dies, creates a continuous ribbon of shell material that is fed into the encapsulation area. As the ribbons pass through the machine, the fill formulation is injected between two sheets of shell material. The machine then seals the sheets together, encapsulating the fill formulation. This continuous process allows for high-speed production of capsules with consistent size and shape.

Following the formation of the capsules, the machine cuts them into individual units. The cutting process is precisely controlled to ensure uniformity in size and shape. The newly formed capsules are then collected and may undergo additional processing steps as needed, such as drying or coating, depending on the specific requirements of the final product. This method allows for efficient, large-scale production of capsules with the desired formulation.

The present disclosure will be more readily understood by referring to the following examples which are given to illustrate embodiments rather than to limit its scope.

### Example 1

### Production of Larger Capsules by Reverse Spherification

The process of reverse spherification was utilized to produce large size capsules. Two methods of preparation were performed. Only the reverse spherification of pre-frozen filling material was successful.

The first method includes the following steps: i) pour 5 ml of a solution of apple ice cider and lactate of calcium (0.75%) into the solution of sodium alginate; ii) maintain in 25° C. for 5 minutes; iii) extract the sphere by overturning slowly into a small sieve; and iv) rinse the sphere in distilled water. It was impossible with this method to form a gelified sphere with a liquid apple ice cider filling.

The second method includes the following steps: i) form an ice sphere by deep-freezing apple ice cider with calcium lactate (0.75%) at −31° C.; ii) drop the ice sphere in the sodium alginate solution; iii) maintain in 25° C. for 5 minutes; iv) extract the sphere by overturning slowly into a small sieve; and e) rinse the sphere in distilled water. This technique produced a gelified sphere with a liquid apple ice cider filling.

Spheres produced with sodium alginate, or sodium alginate and other hydrocolloids such as gum arabic, starches, celluloses, and with pectin, following the reverse spherification of a pre-frozen core presented syneresis within an hour:

### Formulation 1

### Alginate Mixture

Alginate 1.5%
Pectin LM 0.5%

### Filling Material

Calcium lactate 0.75%
Apple cider 5 ml

One sphere produced with alginate, gum arabic, and agar agar, following the reverse spherification of a pre-frozen core presented syneresis within around 24 h hour.

### Formulation 2

### Alginate Mixture

Alginate 1.5%
Gum arabic 0.4%
Agar 0.1

### Filling Material

Calcium lactate 0.75%
Apple cider 5 ml

### Example 2

### Production of Larger Capsules with Mixture by Thermoforming Processes

The following spheres were prepared.

### Formulation 1

| | % |
|---|---|
| Membrane mixture | |
| Water | 75 |
| Carrageenan | 3.7 |
| Xanthan gum | 0.25 |
| Locust bean gum | 0.25 |
| Gum arabic | 1.2 |
| Dextrose | 0.10 |
| Glycerine | 15 |
| Stearic acid | 4 |
| Lecithin | 0.5 |
| Filling material | |
| Gin | 2.5 |
| Apple ice wine | 3.5 |
| Cinnamon | |

### Formulation 2

| | % |
|---|---|
| Membrane mixture | |
| Water | 75 |
| Carrageenan | 3.7 |
| Xanthan gum | 0.25 |
| Locust bean gum | 0.25 |
| Gum arabic | 1.2 |
| Dextrose | 0.10 |
| Glycerine | 18.5 |
| Methylcellulose | 1 |
| Filling material | |
| Lychee puree | 2 |
| Apple juice | 2 |
| Vodka | 1 |

### Formulation 3

| | % |
|---|---|
| Membrane mixture | |
| Water | 75 |
| Carrageenan | 3.7 |
| Locust bean gum | 0.25 |
| Xanthan gum | 0.25 |
| Gum arabic | 1.2 |
| Dextrose | 0.10 |
| Glycerine | 14 |
| Stearic acid | 4 |
| Lecithin | 0.5 |
| Methylcellulose | 1 |
| Filling material | |
| Pineapple juice | 4 |
| Cranberry puree | 2 |
| Vanilla flavouring | 0.01 |

### Formulation 4

| | % |
|---|---|
| Membrane mixture | |
| Water | 75 |
| Carrageenan | 3.7 |
| Locust bean gum | 0.25 |
| Xanthan gum | 0.25 |
| Gum arabic | 1.2 |
| Glycerine | 15 |
| Lecithin | 0.5% |
| Carnauba wax | 0.2% |
| Filling material | |
| Strawberry puree | 5 |
| Basil syrup | 0.5 |
| Vodka | 2 |

### Example 3

### Optimisation of the Edible Film

Various formulations were developed using combinations of hydrocolloids, gums, waxes, fat/oils in a solution of water/glycerin. The composition of the formulations is presented in Table 2. Hydrocolloids and gums are used to improve the elasticity and impermeability of the membranes, fat and oils, as well as waxes were used to increase the water barrier capacity (impermeability) of the films and finally the emulsifiers were used to help the homogeneity of the membrane solution before its solidification.

TABLE 2
Composition of various membrane formulations developed
for the encapsulation of fruit juice/sauce

| | Actif | Quantity (%) | | | | | | | | | |
|---|---|---|---|---|---|---|---|---|---|---|---|
| Ingredients | ingredients | A | B | C | D | E | F | G | H | I | J |
| Distilled water | Water | X | X | X | X | X | X | X | X | X | X |
| Ticaloid 881 M | Carrageenan | X | X | X | X | X | X | X | X | X | X |
| TIC Pretested Gum | Arabic gum | X | X | X | X | X | X | X | X | X | X |
| arabic FT | | | | | | | | | | | |
| Genugel | Carrageenan | X | X | X | X | X | X | X | X | X | X |
| carrageenan CJ | | | | | | | | | | | |
| Genugel | Carrageenan | X | X | X | X | X | X | X | X | X | X |
| carrageenan WR78 | | | | | | | | | | | |
| Genutine 310-C | Carrageenan | X | X | X | X | X | X | X | X | X | X |
| Ticacel LV - | Methylcellulose | X | X | — | — | — | — | — | — | X | X |
| Methylcellulose | | | | | | | | | | | |
| Glycerine 99.5- | Glycerine | X | X | X | X | X | X | X | X | X | X |
| 99.7% USP | | | | | | | | | | | |
| Admul MG 40-04 K | Emulsifier | X | X | X | X | X | X | X | X | X | X |
| Stearic acid | Fat | — | — | X | X | X | X | X | X | — | — |
| Canola oil | Oil | — | — | — | — | — | X | — | X | — | — |
| Carnauba | Wax | — | — | X | X | X | X | X | X | — | — |
| Potassium Chloride | KCl | — | — | — | — | — | — | — | — | X | X |

X: present;
—: absent

Membrane samples evaluated for their resistance against extension forces using a penetration test realized by a TAXT2 texture analyzer. The results of the analyses for three formulations B, C and J are shown the in FIG. 2. The other films showed lower or intermediate resistance. As it is shown in FIG. 2, the formulations B and J showed similar resistance, with a higher extensibility than the other formulations. The formulations B and J showed a pic force of about 280 g before rupture against 80 g for the formulations C. The membrane samples of B and J are able to be extended up to 136 mm (corresponding to 68 sec in the graph) before rupture, while it is only 56 mm for C.

These results showed that adding fats/oils/waxes has adverse effect of the mechanical properties of the membranes.

The resistance of the films against dissolution was also evaluated after soaking the samples of the membrane in apple juice for 30 days. Formulation B showed higher stability. Here again, presence of a wax (ex. Formulation C), fats and oils reduced integrity of the membrane.

Regarding the strong elasticity and mechanical properties, as well as stability in contact with aqueous medium, formulation B was selected for developing capsules of apple sauce.

Capsules of apple sauce made with the formulation B showed some leakage of the liquid trough the capsule membrane. To achieve a complete impermeability, coating layers were added on the capsules.

Coating with solid fat: cacao butter was used for coating the capsules. Although an homogeneous and smooth coating was obtained around the capsules, with an appreciated taste, it takes time for the melted fat to be solidified and it is fragile.

Coating with plant protein was then tested. Mixes of zein (corn protein) and out protein have shown good coating properties. Pieces of the membranes were used to be coated with a solution of zein with or without oat protein. The coating obtained was not enough homogeneous. Moreover, the mix solution being prepared with alcohol limits its application for an industrial production (explosion proof machinery needed and the required time for evaporation and drying is long). The consumers did not appreciate the taste and the texture of zein.

Coating with wax was further tested. A commercial food compatible wax was used for coating the capsule. An opening mechanism was integrated in the coating to facilitate its opening by the consumers before eating. As the wax coating is not edible and it can not be composted, the concept was rejected to avoid environmental pollution.

Coating with agar was successful as 100% impermeability was achieved for 6 months.

Coating with other materials did not result in satisfactory results, mainly with softgel modified corn starch; CSA (composed of maltodextrin, cellulose gum, modified starch); tapioca dextrin (Crystal gum); hydroxypropyl methylcellulose; pectin HM; pectin LM; pectin+pea protein; pre-hydrated gum arabic; pectin+agar; or gum Arabic.

The resulting optimized formulation produces a capsule capable of containing a high water content, strong enough to be handed by the consumer which can shew and swallow the capsule, providing an exciting contrast of textures. The exterior of the capsule remains dry during storage with a shelf life of at least 6 months.

While the disclosure has been described in connection with specific embodiments thereof, it will be understood that it is capable of further modifications and this application is intended to cover any variations, uses or adaptations, including such departures from the present disclosure as come within known or customary practice within the art to which and as may be applied to the essential features hereinbefore set forth, and as follows in the scope of the appended claims.

What is claimed is:

1. An edible non-gelatin soft capsule for encapsulating a bite size of semi-solid or a sip size of liquid material, said bite size of semi-solid or sip size of liquid material comprising a content of at least 20% in water, comprising a heat-sealable and thermoformable membrane of 0.9 to 2 mm in thickness; said thermoformable membrane comprising:
a) an hydrocolloid mixture;
b) at least one phospholipid;
c) at least one plasticizer; and
d) an agar agar coating.

2. The capsule of claim 1, wherein the hydrocolloid mixture comprises at least one of carrageenan, gum arabic, hydroxypropyl methylcellulose, methyl cellulose, starch, and a mixture thereof.

3. The capsule of claim 2, wherein said starch is corn starch, water chestnut starch or maltodextrin.

4. The capsule of claim 1, wherein the at least one plasticizer is at least one of glycerin, polyethylene glycol, sorbitol, polyol, and a mixture thereof.

5. The capsule of claim 1, further comprising at least one sugar, said at least one sugar is at least one of glucose, fructose, galactose, sucrose, dextrose, and a mixture thereof.

6. The capsule of claim 1, wherein the at least one phospholipid is lecithin.

7. The capsule of claim 1, wherein said membrane has a pH of between 4 and 8.

8. The capsule of claim 1, further comprising an anti-tacking or a softening agent.

9. The capsule of claim 1, wherein said membrane has a viscosity of from 1 to 10 Pa·s.

10. The capsule of claim 1, wherein said capsule has volume between 1 ml to 10 ml.

11. The capsule of claim 1, wherein said capsule has a volume for containing at least 1 g to 10 g of material.

12. The capsule of claim 1, wherein said membrane has an elasticity of around 64% compared to the non stretched membrane.

14. The capsule of claim 1, wherein the material is a fruit juice, concentrate or puree, a vegetable juice, concentrate or puree, tree sap, tea, coffee, syrup, honey, a dairy product, an alcoholic beverage, a functional or health enhancing ingredient, maltodextrin, dextrose, or a preparation of medicinal substances or pharmaceutical formulation.

15. A process for manufacturing the non-gelatin soft capsule of claim 1 encapsulating an edible semi-solid or a liquid material comprising the steps of:
a) mixing an hydrocolloid, at least one phospholipid, at least one plasticizer and at least one sugar;
b) heating said mixture at a temperature of about 60° C. to about 100° C. forming a membrane;
c) reducing or removing all air bubbles in the membrane;
d) shaping the membrane into the capsule; and
e) depositing or injecting the material in said capsule.

16. The process of claim 15, wherein the membrane is fed into an encapsulation area of an encapsulation machine creating a continuous sheet, and wherein the material is injected between two sheets of membrane, and wherein further the sheets are sealed together.

17. The process of claim 15, wherein the air bubbles are reduced or removed by applying a vacuum.

18. The process of claim 16, further comprising the step of applying at least one barrier layer on the interior or exterior surface of the membrane.

19. The process of claim 18, wherein the at least one barrier layer and bonding agent are applied before, during or after the sealing of the sheets.

20. The process of claim 18, wherein the membrane is formed by extruding through two extrusion dies or casting said mixture to form the membrane.
